(19) United States
(12) Patent Application Publication
(10) Pub. No.: US 2026/0028848 A1
(43) Pub. Date: Jan. 29, 2026

(54) Trailerable Electricity Generating Canopy Appliance

(71) Applicants: Antonia Ginsberg-Klemmt, Sarasota, FL (US); Achim Ginsberg-Klemmt, Sarasota, FL (US)

(72) Inventors: Antonia Ginsberg-Klemmt, Sarasota, FL (US); Achim Ginsberg-Klemmt, Sarasota, FL (US)

(21) Appl. No.: 19/350,425

(22) Filed: Oct. 6, 2025

Related U.S. Application Data
(63) Continuation-in-part of application No. 18/750,705, filed on Jun. 21, 2024.
Application No. 18/750,705 is a continuation-in-part of application No. 18/348,989, filed on Jul. 7, 2023, now Pat. No. 12,231,083.
Application No. 18/348,989 is a continuation-in-part of application No. 17/981,065, filed on Nov. 4, 2022, now Pat. No. 12,040,737.
Application No. 17/981,065 is a continuation-in-part of application No. 17/326,687, filed on May 21, 2021, now Pat. No. 11,515,833.

(51) Int. Cl. E04H 6/04; B60D 1/06; B60Q 1/44; B62D 21/11; E04H 6/02

(52) U.S. Cl. CPC E04H 6/04; B60D 1/06; B60Q 1/44; B62D 21/11; E04H 6/025

(57) ABSTRACT

A system comprises a canopy appliance system with solar panels providing a carport, and a set of add-on elements comprising wheels and a dolly. With none of the set of add-on elements assembled to the appliance the appliance stands alone on the four posts and provides a carport and electricity to the inverter connector, and with the removable wheels assembled to two rear posts, the stop-tail-signal lights mounted facing rear on the two rear posts, the beam cross piece mounted spanning the forward posts presenting the first trailer hitch, the tubes clamped between posts on each side, the rear posts and the forward posts, the dolly in place with the hitch ball on the dolly engaging the first trailer hitch, the second trailer hitch positioned forward, and the tubes clamped in place, the free-standing appliance becomes a street-legal trailer that may be licensed as such.

### CROSS-REFERENCE TO RELATED APPLICATIONS

The instant application is a continuation-in-part (CIP) of co-pending application Ser. No. 18/750,705, filed on 21 Jun. 2024, which is a CIP of application Ser. No. 18/348,989, filed on 7 Jul. 2023, now issued as U.S. Pat. No. 12,231,083, on 18 Feb. 2025, which is a CIP of application Ser. No. 17/981,065 filed 4 Nov. 2022, now issued as U.S. Pat. No. 12,040,737, on 16 Jul. 2024, which is a CIP of application Ser. No. 17/326,687 filed 21 May 2021 now issued as U.S. Pat. No. 11,515,833, on 29 Nov. 2022. All disclosure of the parent applications is incorporated at least by reference.

### BACKGROUND OF THE INVENTION

### 1. Field of the Invention

The present invention is in the technical area of solar power generation and pertains more particularly to a system configured as a vehicular, trailerable canopy.

### 2. Description of Related Art

Solar systems are notoriously well known in the art and comprise generally a plurality of solar panels that convert sunlight to electrical energy, the solar panels mounted to a fixed structure and connected an electrical apparatus termed an inverter that converts the DC voltage produced by the solar panels to a common voltage useful in a public or private electrical AC grid. In the United States a common voltage for conversion may be 240 volts AC, which is the finally stepped down voltage provided to most homes and businesses from the public grid.

A quite common circumstance involves solar panels mounted on fixed carrier apparatus on the roof of a home or business. This is a common pattern when dealing with a single home or business. In other circumstances solar panels may be mounted and connected in what might be termed a solar farm, where a large area of solar panels may be located on the ground in a rural area, for example, and the electrical output may be provided directly into a public grid, or to a private grid supplying a number of homes or businesses.

It is most common in the art that mounted solar panels are more or less permanently mounted, and not readily moved, such as known for solar panels in a roof installation. Therefore, such panels and the apparatus to which they mount are subject to radical weather events. Exposed panels may be severely damaged, for example, by hurricanes, hailstorms, wind driven debris, tornadoes, falling trees and branches in windstorms, and by a variety of other damaging circumstances.

Further to the above it is well-known that persons possessing such as a carport structure or an electricity-generating carport structure may on occasion have to relocate, or may wish to transfer ownership of the structure. In such a circumstance it will be advantageous if the structure may be converted to a towable trailer.

Given the above discussion the inventors believe that what is clearly needed is a canopy structure that may be converted, by adding a set of elements, into a street-legal trailer.

### BRIEF SUMMARY OF THE INVENTION

In an embodiment of the invention a canopy appliance system is provided comprising a free-standing appliance with a rectangular aspect providing a carport, the appliance having four corner posts, two forward and two rear, upper cross-members joining the corner posts, solar panels joined to individual ones of the upper cross-members, and circuitry and wiring connecting the solar panels to a cable ending in a connector compatible with an inverter, and a first set of add-on elements comprising removable wheel assemblies, stop-tail-signal lights, clamps, tubes, a beam cross piece having a first trailer hitch, a two-wheel dolly with a vertical post having a hitch ball, a forward extension ending in a second trailer hitch, and wiring for the stop-tail-signal lights. In a stationary mode with none of the set of add-on elements assembled to the appliance the appliance stands on the four posts and provides a carport and electricity to the inverter connector, and wherein in a trailering mode with the first set assembled, including the removable wheel assemblies on the rear posts, the beam cross-piece on the forward posts, the tubular bracing members clamped between the forward and rear posts on each side, the dolly coupled to the first trailer hitch to present the second trailer hitch forward, and the lights wired, the appliance is configured as a street-legal trailer.

In one embodiment the system comprises a second set of add-on elements with ground-anchoring assemblies configured to restrain the appliance against uplift and sliding, wherein in a secured mode the ground-anchoring assemblies of the second set are fastened to one or more posts and to a supporting surface to restrain the appliance. Also in one embodiment the ground-anchoring assemblies comprise (i) hard-surface anchors configured for removable attachment to asphalt or concrete, the hard-surface anchors selected from the group consisting of mechanical expansion anchors, drop-in anchors, wedge anchors, adhesive/chemical anchors, and post-installed anchor sleeves, each engageable through an anchor interface member fixed to the appliance, or (ii) soft-ground anchors comprising helical screws or piles configured to be driven into soil and coupled to the appliance through the anchor interface member. In one embodiment the hard-surface anchors comprise adhesive anchors installed in drilled holes and torqued to a specified value, and the anchor interface member includes anti-rotation features selected from serrations, shear keys, or dowel pins. And, in one embodiment the soft-ground anchors comprise helical screws having a coupling bracket that captures a lower edge of the anchor interface member and clamps thereto using a quick-release fastener.

In one embodiment the anchor interface member is removably coupled to a lower region of a corner post and further comprises a license-plate bracket oriented rearward. Also, in one embodiment the anchor interface member includes a load-indicator configured to provide a visual indication when a preset anchor tension or compression threshold is reached. Also, in one embodiment the system further comprises ballast trays configured to receive sandbags or pavers and to interlock with the anchor interface member to increase vertical hold-down in locations where penetrating anchors are restricted. In one embodiment the ground-anchoring assemblies are tool-less removable from the appliance, leaving flush or capped anchor points in the supporting surface. In one embodiment each removable wheel assembly comprises two shock absorbers and two compression springs arranged in parallel between a three-sided weldment enclosing a rear post and a forked wheel frame pivotably mounted to the post.

In one embodiment the three-sided weldment presents attachment brackets for ends of the springs and shock absorbers and further carries a rear-facing light pod and a license plate holder. And in one embodiment the stop-tail-turn-signal lights are wired through the tubular bracing members to a standard trailer electrical connector presented at the forward extension of the dolly.

In another aspect of the invention a method for converting a free-standing canopy appliance in a rectangular aspect providing a carport, the appliance having four corner posts, two forward and two rear, upper cross-members joining the corner posts, solar panels joined to individual ones of the upper cross-members, and circuitry and wiring connecting the solar panels to a cable ending in a connector compatible with an inverter, into a street-legal trailer is provided, comprising: providing a first set of add-on elements comprising removable wheel assemblies, stop-tail-signal lights, clamps, tubes, a beam cross piece having a first trailer hitch, a two-wheel dolly with a vertical post having a hitch ball, a forward extension ending in a second trailer hitch, and wiring for the stop-tail-signal lights, and assembling the set of add-on elements to the free-standing canopy appliance.

In one embodiment the method further comprises securing the appliance against uplift and sliding by coupling ground-anchoring assemblies to a supporting surface through an anchor interface member of the appliance. In one embodiment securing the appliance against uplift sliding comprises: (i) for hard surfaces of asphalt or concrete, installing mechanical expansion or adhesive anchors through the anchor interface member into drilled holes; and (ii) for soft ground, driving helical screws into soil and coupling the helical screws to the anchor interface member. Also, in one embodiment the method further comprises providing a suspension system for the street-legal trailer wherein the removable wheel assemblies comprise each, one or more compression springs and shock absorbers. Also, in one embodiment the method further comprises placing and anchoring a three-sided weldment sized to each of the rear posts, wherein with the weldments clamped on the posts and secured, attachment brackets are presented for one end of the compression springs and shock absorbers. In one embodiment there are two shock absorbers and two compression springs in each removable wheel assembly. In one embodiment the method comprises wiring the stop-tail-signal lights mounted on the two rear posts through tubes clamped between the forward and the rear posts to a conventional electrical connector at the forward extension of the dolly. And in one embodiment the method further comprises mounting a license plate holder facing to the rear.

### BRIEF DESCRIPTION OF THE SEVERAL VIEWS OF THE DRAWINGS

FIG. 1 is a perspective view of a movable framework in an embodiment of the present invention.

FIG. 2 is a perspective view of the framework of FIG. 1 showing where solar panels are mounted in an embodiment of the invention.

FIG. 3 is a plan view of an upper level of the framework showing six solar panels mounted in an embodiment of the invention.

FIG. 4 is an end view of the framework showing how additional solar panels may be added to the framework.

FIG. 5 is a perspective view of a frame mounted to the side tubes to better illustrate the nature of the mounting in this embodiment.

FIG. 6 illustrates the movable framework with mounted solar panels positioned in a driveway leading to a garage door.

FIG. 7 is a perspective view of the framework in the driveway with outside panels lowered.

FIG. 8 is a perspective view of the driveway with the framework rolled into the garage.

FIG. 9 is a perspective view of a driveway with tracks to guide the framework as the framework is moved.

FIG. 10 is an end view of the framework in an embodiment employing a drive motor and wheel.

FIG. 11A is a perspective view of a solar canopy structure in another embodiment of the invention.

FIG. 11B is a perspective view of the structure of FIG. 11A with tubes removed to produce two separate portable units.

FIG. 12 is a perspective view of a MEGA canopy in one embodiment of the invention.

FIG. 13 illustrates a rectangular flat base of the canopy of FIG. 12 in an embodiment of the invention.

FIG. 14 is a perspective view of the canopy of FIG. 12 with solar panels raised in an embodiment of the invention.

FIG. 15 is a side elevation view of a framework of the canopy of FIG. 12 in an embodiment of the invention.

FIG. 16 is an end elevation view of a framework of the canopy of FIG. 12 in an embodiment of the invention.

FIG. 17 illustrates a high-load wheel assembly mounted to a post in an embodiment of the invention.

FIG. 18 illustrates the wheel assembly of FIG. 17 from a different viewpoint in an embodiment of the invention.

FIG. 19 illustrates an anchor system in an embodiment of the invention.

FIG. 20 is a side elevation view of a VEGA Canopy in an embodiment having a trailer dolly and rear wheels.

FIG. 21 is a rear elevation view of the VEGA canopy appliance of FIG. 20.

FIG. 22 is a center section view of the VEGA canopy appliance of FIG. 20.

FIG. 23 is a side elevation view of a VEGA Canopy in an alternative embodiment.

FIG. 24 is a center section view of the VEGA canopy appliance of FIG. 23.

FIG. 25 is a side elevation view of the VEGA canopy appliance of FIG. 23 showing a travel cover.

FIG. 26 is a perspective view of a free-standing canopy structure that may be used as a carport, and may also generate electricity.

FIG. 27A is a perspective view of a wheel assembly on a post at a rear of a trailer formed from the structure.

FIG. 27B is an exploded view of elements in FIG. 27A.

FIG. 28 is a perspective view of a front of the trailer of FIG. 27A.

### DETAILED DESCRIPTION OF THE INVENTION

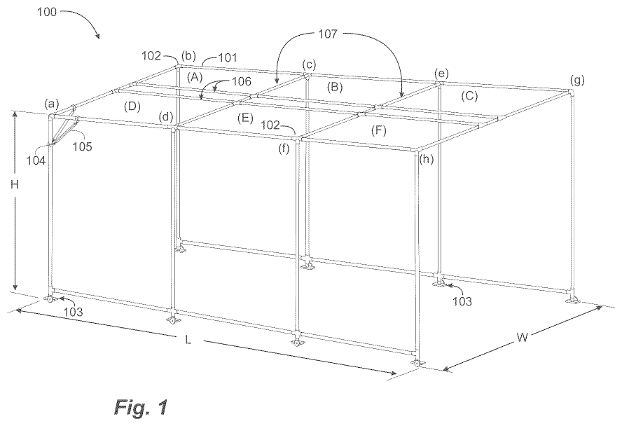

FIG. 1 is a perspective view of a movable framework 100 in an embodiment of the present invention. Framework 100 in this example is constructed of aluminum tubes sections such as section 101 which are joined by cast aluminum fittings such as fitting 102, which is a corner fitting. Many such fittings are commercially available. In the present example the tubes are standard 2.0 inch OD aluminum tubes, and once joined with a fitting, tubes sections are TIG welded to the fittings.

Each upright (vertical) element in framework 100 ends at the lowermost extremity with a wheel assembly such as assembly 103. In this example there are eight such wheel assemblies. In some embodiments there may be more or fewer than eight, and the wheel assemblies may have a locking brake. In alternative embodiments the wheels may be extendable and retractable, such that the framework may be caused to rest directly on a supporting surface with the wheels raised.

One corner (a) of the framework is shown to be reinforced by braces 105 between clamps 104 fastened to the aluminum tubes. Although not explicitly shown in the figure, corners (b) through (g) may be similarly braced, and typically will be so braced. This triangulation adds needed strength and rigidity to the framework.

In FIG. 1 it is seen that the framework has a horizontal upper level defined by corners (a), (b), (h) and (g). This upper level is divided in this example by two lengthwise tube arrangements 106 and by two lateral tube arrangements 107, into six rectangular regions labeled in this example (A), (B), (C), (D), (E) and (F). These regions are sized by the placement of these tube arrangements to be of the size of solar panels to be used with the system, as is described in enabling detail below.

Framework 100 has a height H, a width W, and a length L in this example, and these dimensions are important to the purpose of the invention. In one embodiment the framework supports solar panels in a solar panel system that doubles as a canopy and utilizes driveway space to expose solar panels to sunlight to generate electrical energy, which may be used both for supplementing electrical power in a household or commercial building associated with the driveway or parking space, and to charge batteries for electrical vehicles that may be under the framework or in a nearby garage. Width W for purposes of the invention needs to be wider than an automobile associated with the system in a use case, but more narrow than a width of a garage doorway associated with the system, length L needs to as long as or longer than the automobile, and height H needs to be higher than the overall height of the automobile but less than the height of the garage door. It will be apparent that these dimensions may vary depending on use case and application, but one set of dimensions may well work for most applications.

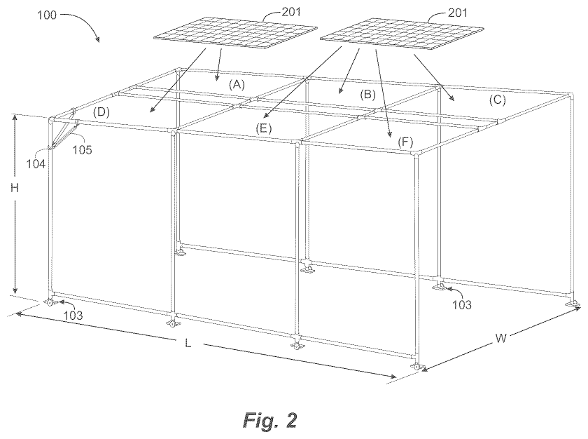

FIG. 2 is a perspective view of framework 100 of FIG. 1 with solar panels 201 shown to be added to regions (A) through (F). In this example the solar panels are GCL-M6/72DH Bifacial panels. Bifacial means that the 12 solar cells that make up one solar panel 201 are made to be active on both sides. When installed in regions (A) through (F) of the framework these six panels will be active especially for sunlight from above but will also be active and will generate electricity by reflected sunlight from surfaces of a vehicle under the framework.

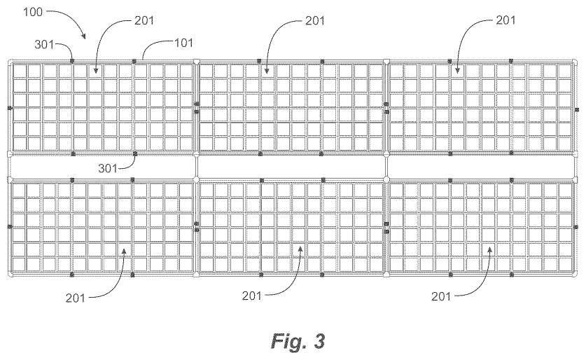

FIG. 3 is a plan view of the upper level of framework 100 with solar panels 201 installed in each of the six regions (A) through (F) in this example. In this example the solar panels are GCL-M6/72DH Bifacial panels as indicated above, with each panel about 80 inches in length, so the overall length of the structure is a little more than three times this dimension, or about 20 feet in length. The width is about 8 feet. The solar panels are retained within each of regions (A) through (F) by use, in this example, of connectors 301, which in this example are clamps that are attached over the 2 inch tubes of the tubular frame, and connect to holes on the sides of the solar panels. This, it will be understood, is just one of a variety of ways that the solar panels may be secured in the regions of the framework. In the example of FIG. 3 there are 6 solar panels exposed to sunlight, but the structure in embodiments of the invention is not limited to 6 panels.

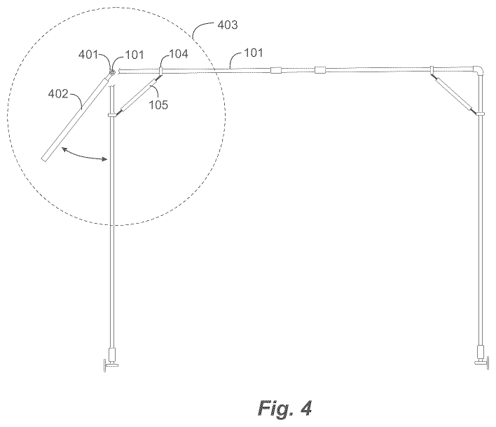

FIG. 4 is an end view of framework 101 showing mounting of additional panels to outside tubes of the framework in a manner that the additional panels may be rotated into a horizontal position for maximum effect and may be rotated to a nearly vertical position to enable the framework to minimize the overall width to enable the structure to be moved, for example, from a driveway to inside a garage. In FIG. 4 a corner cast aluminum fitting is removed in the figure to show a clamp mechanism 401 mounted to a lengthwise upper tube, with the clamp mechanism attached to a panel frame 402 which may hold a solar panel. The frame 402 is shown at an angle of about 30 degrees from vertical but may be lowered to minimize the overall width of the structure or raised so that a mounted solar panel in frame 402 may be horizontal for maximum sunlight exposure.

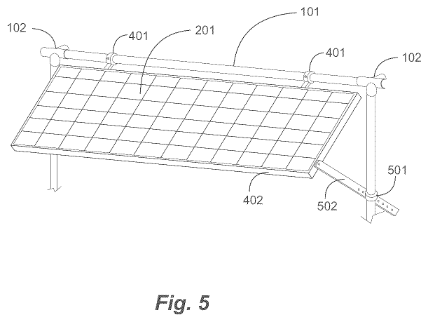

FIG. 5 is a perspective view of frame 402 mounted to the side tube 101 to better illustrate the nature of the mounting in this embodiment. Frame 402 mounts a solar panel 201 the same as the solar panels mounted in the upper level as shown in FIG. 3. Clamp mechanisms 401 may be loosened to rotate frame 402 and tightened to secure the frame, and therefore the solar panel, at a new attitude, including a horizontal attitude parallel with the solar panels mounted in the upper level. In an alternative embodiment there may be props 502 connecting to anchors 501 by which the side panels may be raised or lowered. It will be apparent that there are a variety of ways that side frames 402 carrying solar panels may be raised or lowered.

As many as six frames 402 with solar panels 201 may be provided along the sides of the framework, three along each side, which effectively doubles the number of solar panels in the apparatus, to twelve.

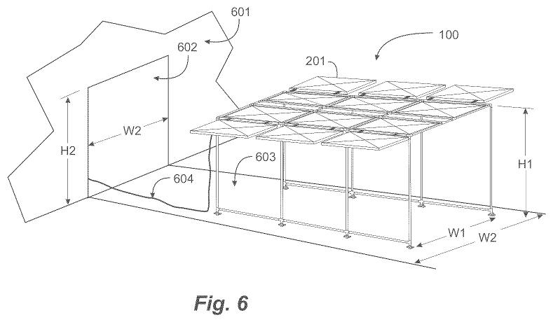

FIG. 6 illustrates movable framework 100 with a full complement of mounted solar panels 201 positioned in a driveway or parking space 603 leading to a garage door 602 in a side of a home or business 601. It may be seen that the extra side panels to each side of the framework are deployed level with the solar panels in the top of the framework such that all twelve solar panels are parallel and horizontal. Width of the driveway is W2 which is greater than the width W1 of framework 100. The width of the garage door opening is also W2, the same as the width of the driveway in this example. The height of the framework Hl is less than the height w2 of the garage door. The deployment of the side panels provides maximum energy generation, which is routed to an inverter in the garage by a cable 604, but this makes the overall width greater than the width W2 of the garage door. In this configuration the moveable framework cannot be rolled into the garage.

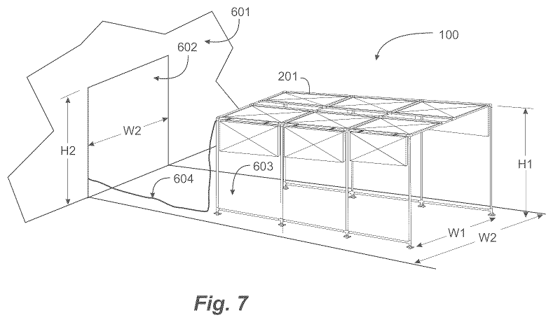

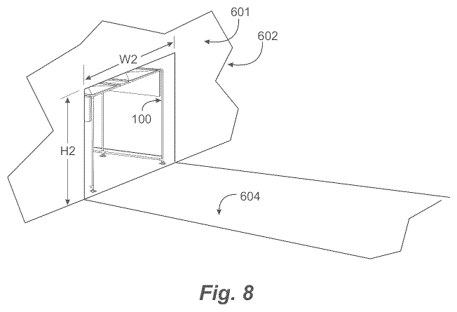

FIG. 7 illustrates the circumstance of FIG. 6 except the side panels have been retracted to a vertical position, reducing the overall width of the framework with panels to W1. In this configuration the framework with panels may be rolled into the garage through the garage door. FIG. 8 illustrates the framework 100 with solar panels moved into the garage through the garage door.

In the examples shown and described, with a framework with solar panels stored in the garage, an automobile, a truck or motorcycles may still be parked in the garage beneath the framework, as the inside height and width of the framework is high and wide enough to clear most automobiles. A user may open the garage door and manually roll the framework on wheel assemblies 103 out of the garage through the garage door, trailing cable 604 until the framework is fully deployed in the driveway. The side panels may then be deployed level, and the system will generate electricity. At a time when a weather event, or for some other reason it is determined to store the framework in the garage the side panels may be lowered, the garage door opened, and the framework may be rolled back into the garage with enough space to also park the car underneath.

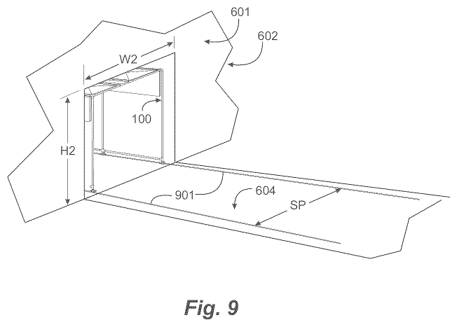

Cable 604 in one embodiment ends in a standard 240 volt connector, which may be plugged into an inverter to connect into the house or business wiring, and the solar panel system will supplement electrical usage in the home or business as an electricity generating appliance. In one embodiment the inverter is a Solar Edge™ HD Wave inverter which accepts a 240V connector and also provides connectors for charging electric vehicles. The inverter in one embodiment is mounted just inside the garage door but may be positioned elsewhere as well. The entire system functions as an electricity generating, portable appliance in one unit. FIG. 9 illustrates an embodiment of the system wherein optional tracks 901 are provided on the driveway at a spacing SP to match the distance between wheels 103 on the movable framework. The optional tracks may be either cut into the driveway or strips of material may be laid onto and adhered to the surface of the driveway to form the tracks. The optional tracks guide the framework both going into and coming from the garage.

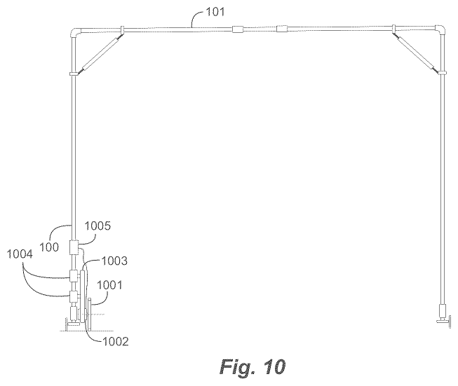

FIG. 10 illustrates an alternative embodiment wherein a single wheel 1001 driven by a DC motor 1002 mounted in a frame 1003 fastened to an upright of the framework by clamps 1004 is provided on one side at a lower level of the framework at the end of the framework that first enters and last leaves the garage. The motor may be driven in either direction and turned on and off to propel the framework from the garage and to bring it back into the garage. On-off and direction inputs may be provided on a small junction box 1005 fastened to an upright of the framework near the motor and wheel. In an alternative embodiment there may be circuitry in junction box 1003 with Bluetooth or other wireless communication capability, and an application may be provided on a smart phone with an interactive interface to operate the drive wheel to propel the framework into or out of the garage. This apparatus works best in an embodiment wherein tracks, as in FIG. 9, are provided to constrain the wheels 103 of the framework.

In one embodiment cable 604 that connects the solar panels of the apparatus of the invention to an inverter may be wound on a reel in the garage with spring constraint, such that the cable plays out as the framework is moved from the garage to a position in the driveway, and winds back on the reel as the framework re-enters the garage.

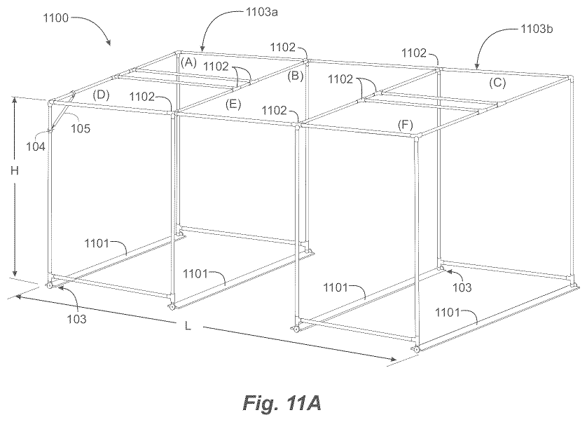

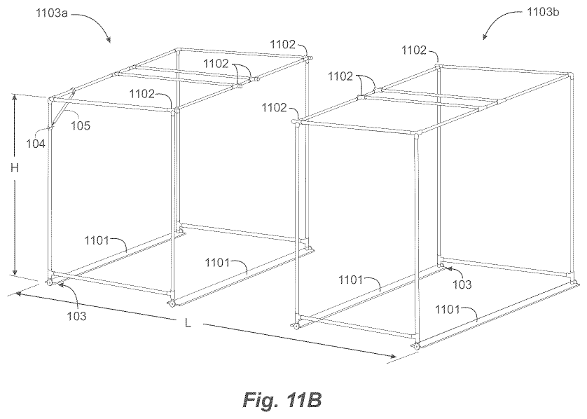

FIG. 11A is a perspective view of a structure for a portable solar canopy in another embodiment of the invention. In this embodiment two rectangular structures 1103a and 1103b that are mirror images are joined by tubes only at the upper level, the tubes engaged in fittings 1102 that are fittings that enable the tubes to be engaged and disengaged. The structures are joined side-to-side additionally by flat bars 1101.

In this embodiment wheel assemblies 103 are of a commercially available sort well-known in the art that may be deployed and retracted such that the structure may be slightly raised on caster wheels that allow universal horizontal movement and lowered to cause the structures to rest on the flat bars 1101.

With the structures 1103a and 1103b joined as shown in FIG. 11A solar panels may be mounted exactly as described above with reference to FIG. 2 and also referenced in other descriptions, and the joined structure may reside on a driveway providing electricity generation just as described herein in other embodiments.

When a user has determined to store the portable solar canopy in a garage or other storage area the user may disconnect the tubes joining structures 1103a and 1103b by releasing the tubes joined by fittings 1102 and removing the tubes. FIG. 11B illustrates the result, with structures 1103a and 1103b now separate structures, separately movable. The user may now deploy the caster wheel mentioned above to raise the structures separately on the caster wheels, and each structure may be separately rotated and moved into the garage separately. This innovation provides a means of moving and deploying the overall structure of the portable solar canopy that is easier for the user to manually manipulate.

In one embodiment of the invention individual ones of the solar panels may be connected directly to a micro-inverter, converting the direct current (DC) produced to an alternating current (AC).

Having illustrated and described a number of examples of the invention it is again emphasized here that the framework is open both in the front and the rear with sufficient height and width that a user may park an automobile or other vehicle under the framework with the framework positioned in the driveway to present solar panels to sunlight. Moreover, the user may drive a vehicle under and through the framework and into the garage. The system of the invention presents no real impediment to the use of the garage or the driveway.

### MEGA Version

In alternative embodiments of the invention a more robust and serviceable version of the solar canopy appliance is provided with additional functionality over the embodiments described above. MEGA stands for Mobile Electricity Generating Appliance.

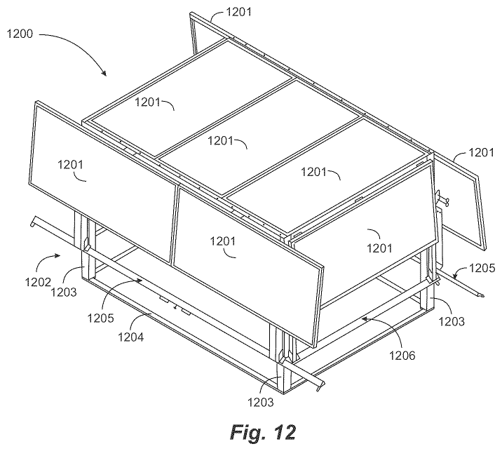

FIG. 12 is a perspective view of a VEGA canopy 1200 in one embodiment of the invention. Canopy 1200 comprises nine (9) bifacial solar panels 1201 one of which is not seen in FIG. 12, being implemented on a far end of the canopy not visible in the view of FIG. 12. In FIG. 12 panels 1201 are carried on a sturdy framework 1202 having four corner posts 1203 (three corner posts are visible in FIG. 12) that are made from 4″×4″ aluminum square tube stock. In one embodiment the wall thickness of the square tube stock is ⅛ inch, but in some instances, for a more sturdy version, tubes with a wall thickness of 3/16 inch or even ¼ inch may be used. Two solar panels 1201 on each long side and one solar panel on each width end are hinged at an upper edge and folded down in a position suitable for moving the portable solar panel. Lengthwise and widthwise cross braces are implemented in framework 1202 but not seen under the folded down solar panels on the sides and ends of the canopy.

A rectangular flat base 1204 with four sides each in one embodiment one-half the width of a post 1203 (2″) lies flat on a support surface, such as a driveway, which support surface may be concrete or asphalt, and posts 1203 of framework 1202 are joined to this base at the four corners, such as by steel bolts.

Two lengthwise support structures 1205 are hinged to corner posts 1203 on each long side in a manner that the support structures may be deployed to support the two solar panels on each side of the canopy when those panels are raised on their hinged edges to a horizontal plane with the solar panels on the top of the canopy. Similarly, there are two support structures 1206, one on each end of the canopy, hinged to the corner posts of the framework on each end, which may be deployed to support the single solar panels on each end of the canopy when those panels are raised on their hinged edges to a horizontal plane with the solar panels on the top of the canopy. When the four side and two end solar panels are raised and supported horizontally there are nine (9) solar panels in a horizontal plane displayed to catch maximum rays.

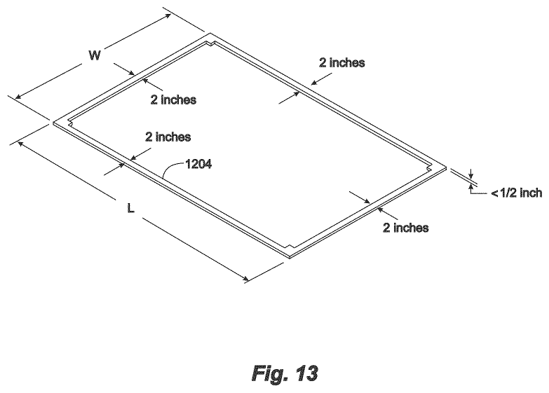

FIG. 13 illustrates rectangular flat base 1204 in the same aspect as in FIG. 12. Base 1204 lies flat on the supporting surface, which may be a driveway surface, such that, with the framework 1202 engaged and the solar panels raised, a car, truck or other vehicle may be driven over the base under the canopy through either the ends or the sides of the canopy. Base 1204 has a length L and a width W which are also the width and length of the framework in a canopy on the base. In one embodiment W is about 8 feet and length L is about 20 feet, but both of these dimensions may be different in other embodiments. A 4″ by 4″ region is implemented on each corner of base 1204 to mate with the 4″×4″ bottom of the corner posts 1203. In an alternative embodiment the width of each span of the base may be 4″ rather than two inches.

Base 1204, having a limited height, such as equal to or less than one-half inch, provides considerable structural support for the framework and presents very little impediment to a vehicle driven over a span of the base. The length and width of base 1204 may vary in different embodiments, but with framework posts 1203 at 4 inches square, the width of each span of base 1204 will be 4 inches.

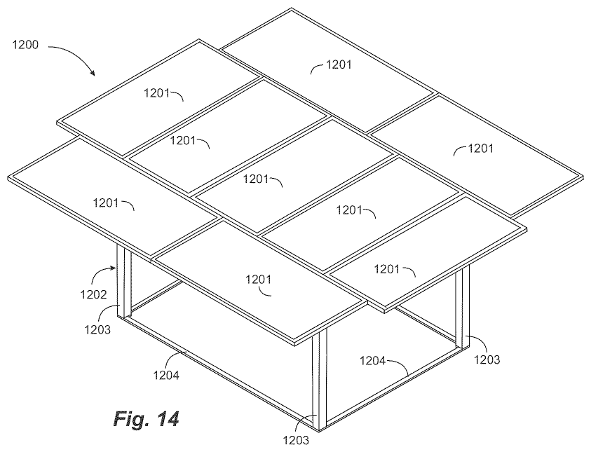

FIG. 14 illustrates the canopy 1200 with the six hinged solar panels raised to the horizontal plane of the three solar panels that are arrayed on the top of the framework and are not hinged. The apparatus 1205 and 1206 that are hinged on the corner posts are not seen in FIG. 14 under the solar panels. FIG. 14 shows the canopy in an arrangement for operation, with all of the solar panels in horizontal aspect and coplanar.

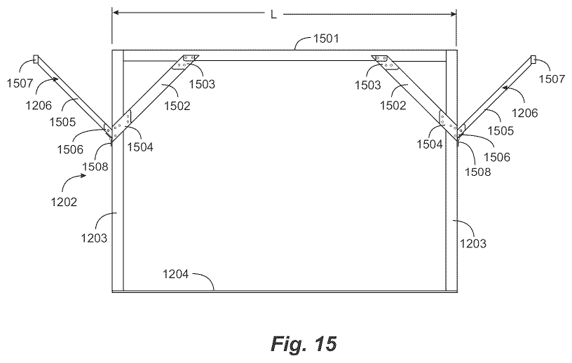

FIG. 15 is a side elevation view of framework 1202 with apparatus 1206 on hinges 1508 on each end raised in position to support the single hinged solar panels on each end of the canopy in a horizontal aspect. Apparatus 1206 in FIG. 12 is shown as folded down against posts 1203, which allows the solar panels on the ends to fold down to a vertical aspect. Each apparatus 1206 comprises an arm 1505 made from square aluminum tubes, hinged in a bracket 1506 that is fastened to post 1203. A rail 1507 fastened in a horizontal aspect at ends of arms 1505 supports the end solar panels in the raised aspect.

A 4-inch L-shaped beam 1501 in this example spans between posts 1203. Beam 1501 is supported on each end to posts 1203 by a 4-inch square brace 1502 fastened between brackets 1503 and 1504, which brackets in this example fasten respectively to the beam and to the posts.

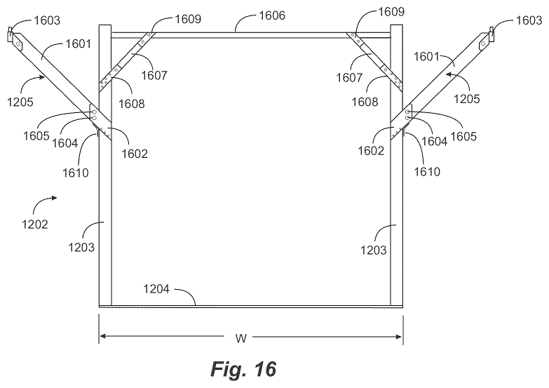

FIG. 16 is an end elevation view of framework 1202 with hinged apparatus 1205 on each side raised in position to support the two hinged solar panels on each side of the canopy in a horizontal aspect. Apparatus 1205 in FIG. 12 is shown as folded down against posts 1203, which allows the solar panels on the sides to fold down to a vertical aspect. Each apparatus 1205 comprises an arm 1601 made from 4″ square aluminum tubes in this example, hinged in a bracket 1602 that is fastened to post 1203. A rail 1603 fastened in a horizontal aspect at ends of arms 1601 supports the side solar panels in the raised position. Arm 1601 pivots on a hinge 1610, pins 1604 & 1605 are inserted in the raised position to support arm 1601.

Canopy 1200 as described in the VEGA version is intended to be deployed on premises, such as on a driveway in front of a garage, on a semi-permanent basis. Earlier versions described above had deployable and retractable wheels such as wheel assemblies 103 described above. It has been determined that it may be better to have removable wheel assemblies, since the canopy may need to be moved only occasionally, and the wheel assemblies may be best not exposed to the elements except when needed. Further, it has been determined there needs to be a means of anchoring the canopy to the surface upon which it rests, as some driveways are not level, and wind may occasionally be a problem. In some regions tornadoes or hurricanes may be a problem.

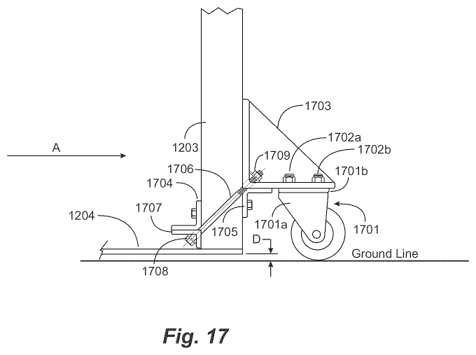

FIG. 17 is an elevation view of one corner post 1203 of the MEGA version canopy illustrating a removable, high-load wheel assembly 1701 having a wheel made in this example from a Ultra High Molecular weight (UHMW) polymer. Wheel assembly 1701 has an upper portion 1701b that bolts under a bracket 1703 by four nuts and bolts of which 1702a and 1702b may be seen in the figure, and a lower part 1701a that is free to rotate relative to part 1701b around a vertical axis. Bracket 1703 is about two inches wider than post 1203 in this example, about six inches, and extends one inch from each side of post 1203. Bracket 1703 is not bolted to post 1203, but rests on an L-bracket 1705 that is the width of the post, four inches, and is bolted to post 1203. A second L-bracket 1704 also of four-inch width is bolted to post 1203 on an opposite side from L-bracket 1705 at a predetermined lower position. A third L-bracket 1707 has a width of six inches, like bracket 1703, and two holes at an angle, passing through the bracket at the corner as shown, in the extended portions outside the post. Bracket 1703 has similar holes in the extended portions outside the post. Some embodiments use angles between 10 and 80 degrees and preferably between 25 and 65 degrees. Two long steel bolts 1706 in this example pass through the angled holes in brackets 1703 and 1707 and are constrained at the top end by a nut and washer 1708 and 1709. Only one bolt and one nut and washer is seen in this view.

A person of skill in the art will understand that with nut 1709 loosened such that bracket 1703 is not urged against bracket 1705, the framework of the canopy will rest on the supporting surface at the ground line. As the nuts are tightened, bracket 1703 is drawn against bracket 1705, and the framework is lifted from the ground line to a height “D” which is determined by the relative positions of brackets 1704 and 1705.

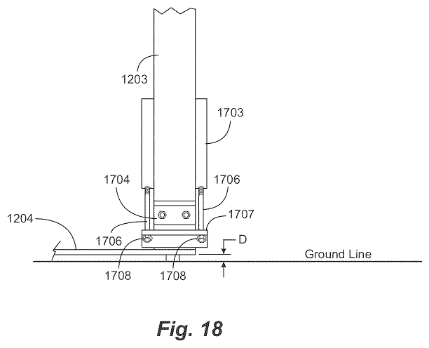

FIG. 18 is a view of the assembly of FIG. 17 in the direction of arrow A in FIG. 17, to better illustrate the nature of the assembly. Bracket 1704 is seen bolted to post 1203 on the near side of the post, and bracket 1707 is seen with bolt 1706 passing through at an angle. Bracket 1703 may be seen on the far side of post 1203 with threaded rods 1706 passing through bracket 1703 at an angle. The threaded rods are secured to bracket 1703 by nut and washer sets 1709, not seen in FIG. 18 but shown in FIG. 17.

The apparatus illustrated in FIGS. 17 and 18 may be implemented at all four corners of the canopy 1200, and once installed and secured the entire canopy is raised on wheels and may be moved along the supporting surface either to store in a garage or other storage facility. The canopy may be moved as well on the wheels to a different location or onto a conveyance vehicle to be carried away.

The inventor believes the apparatus shown in FIGS. 17 and 18 is capable of supporting the considerable weight of the MEGA version of the canopy and facilitating the mobility of the canopy. When the canopy is moved or repositioned, and is in a position desired by the user, the wheel assemblies may be removed, placing the canopy back on the supporting surface.

Once replaced on the supporting surface there may be occasion of expected high winds, even a tornado or a hurricane, that could move or damage the canopy. To protect against such an occurrence, if it is neither desirable nor possible to move the framework inside a shelter, an anchoring system is provided to secure the canopy by its framework to the supporting surface.

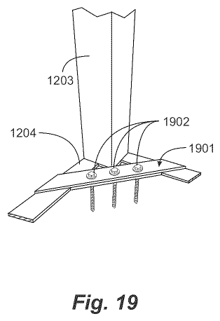

FIG. 19 illustrates one corner post 1203 of the MEGA version of the canopy in one embodiment. A cross brace 1901 is placed at an angle between spans of base 1204. Some embodiments use angles between 10 and 80 degrees and preferably between 25 and 65 degrees. There are three through holes in the cross brace and anchor bolts 1902 are used to anchor the canopy to the supporting surface. One such cross brace with anchor bolts is used preferably at each corner post to very securely anchor the canopy to the surface.

In some embodiments a base 1204 may not be used. In this circumstance a cross brace similar to element 1901 may be attached directly to a corner post, and in some embodiments without a base plate a foot of greater horizontal area than the post may be attached to the post. The cross brace may in this circumstance be attached to the foot at the base of the post.

In one embodiment, once the canopy is deployed on a driveway or other supporting surface, the anchoring cross braces are installed if not already in place. Locations for anchors in the supporting surface are marked through the three holes in each cross brace. The canopy is moved aside a short distance, and holes are drilled in the surface and anchors are installed to accept the anchor bolts. Once the anchors are installed the canopy may be positioned properly over the anchor points and the anchor bolts engaged to securely anchor the canopy to the supporting surface.

### VEGA Version

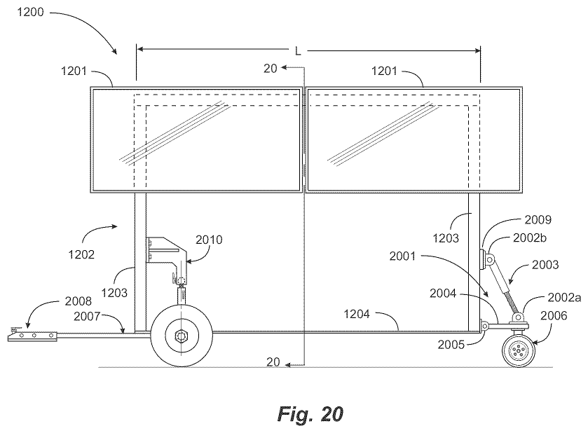

In another aspect of the invention a VEGA (vehicular) Canopy, more properly a Vehicular Electricity Generating Canopy Appliance, is provided that may be towed by an automobile or a truck for relocation. FIG. 20 is a side elevation view of such a VEGA Canopy 1200 showing a sturdy frame 1202 having corner posts 1203 as shown in FIG. 12, a rectangular flat base 1204, and solar panels 1201 folded downward for transit. A removeable, wheeled assembly 2001 on a rear portion of the canopy has a pivoted base 2004 with a first bearing pivot 2002a on the base and a second bearing pivot 2002b attached to corner post 1203. There is a combination spring/shock assembly 2003 attached between the two bearing pivots. A caster assembly 2006, which may be a commercially available assembly such as a Hamilton R-7210-PR assembly, which is a rigid unit, is attached below the base. There is no need in this version for a swivel caster assembly. Base 2004 is free to pivot vertically around a bearing pivot 2005, also attached to the corner post, against the spring and shock assembly. The assembly seen in this side view is one of at least two on the rear of the canopy, with a second assembly joined to the corner post beyond the corner post seen in FIG. 20.

In this example a trailer dolly 2007 is provided at a forward portion of the canopy to carry the forward portion in transit, and the trailer dolly has a commercial hitch 2008 compatible with standard hitch balls. A bracket assembly 2010 is fastened spanning the corner posts at the front of the canopy to mate with a vertically-extended ball of the trailer dolly 2007.

The skilled person will understand that the VEGA canopy appliance is made such that a car may pass under the structure with the solar panels in either direction, lengthwise or widthwise, with the solar panels deployed. Accordingly, it will be apparent that at least bracket assembly 2010 will need to be provided and assembled to the front corner posts of the canopy at the time that a user wishes to tow the canopy and removed to place the canopy again on a ground surface.

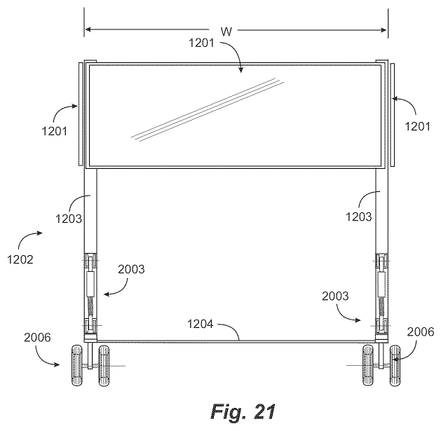

FIG. 21 is a rear elevation view of the canopy of FIG. 20 illustrating the two spring and shock units 2003 attached to the rear-facing surfaces of the rear two corner posts 1203. There are two combination spring/shock assemblies 2003 one on each side of the canopy. Each set of wheels with spring and shock absorber may operate independently. The two assemblies are relatively easy to add to a canopy and to remove if such is desired. Both may be retracted with the casters off the ground surface without occluding the width between the corner posts for a vehicle to pass.

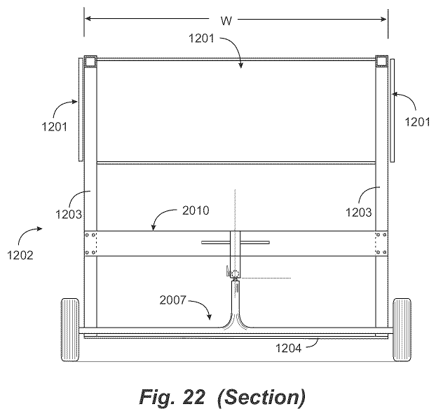

FIG. 22 is a section view from the same viewpoint as FIG. 21, with the section line through a midpoint of the length of the canopy, to be able to illustrate the placement of trailer dolly 2007 in the embodiment shown in FIG. 20. Bracket assembly 2010 is shown bolted across the inside edges of the corner posts in front. Trailer dolly 2007 presents a ball for a hitch on the bracket assembly 2010. The front weight of the canopy in transit is carried by the trailer dolly connected to bracket assembly 2010.

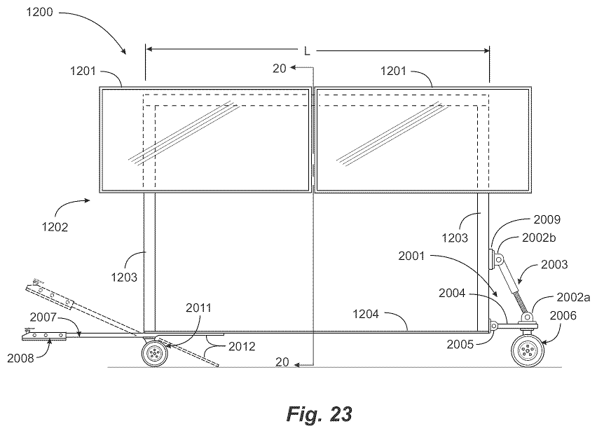

FIG. 23 is a side elevation view of a VEGA canopy in yet another embodiment. In this embodiment the casters with shocks and springs attached to the rear corner posts are the same as in the version illustrated in FIG. 20 and FIG. 21. In this version the dolly has a plate of the width of the canopy, underlying both forward corner posts, and there are two swivel casters 2011, one fastened to the plate directly under each corner post. The swivel casters are of the trailing sort, with an angled post, The plate has a forward central extension to the ball hitch 2008 and a rearward extending portion 2012 of the width of the canopy, which, with the ball hitch raised as shown in FIG. 23 provides a loading ramp 2012 which may be positioned against ground surface by lifting the forward region of the dolly. The position of the ramp when tilted is shown in FIG. 23 in dotted outline. Once the frame is loaded up the ramp, which may be done in several ways, and the dolly is repositioned with the ramp level there may be fasteners (not shown) to attach the frame to the ramp and the dolly.

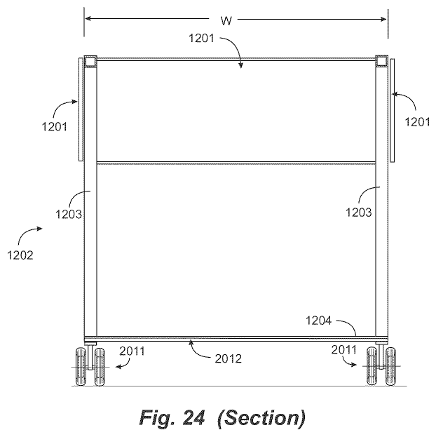

FIG. 24 is a section view from the same viewpoint as in FIG. 22 showing plate 2012 underneath flat base 1204 of the canopy and the two swivel casters 2011, one directly beneath each forward corner post.

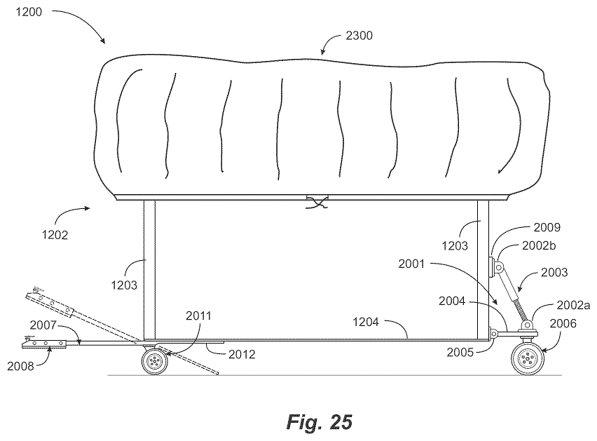

FIG. 25 is a side elevation view like FIG. 20 with a canvas cover 2300 installed over the canopy for protection in transit and tied down. Cover 2300 in one embodiment is a cover with an inner and an outer layer with a filling to provide a cushioning effect for elements of the canopy in transit.

### TEGA Version

In one embodiment of the instant invention a Trailerable Electricity Generating Canopy Appliance (TEGA) is provided in which a free-standing canopy appliance may be modified by a set of add-on elements that convert the free-standing canopy appliance into a public street-legal licensed trailer that may be towed legally on public streets and highways.

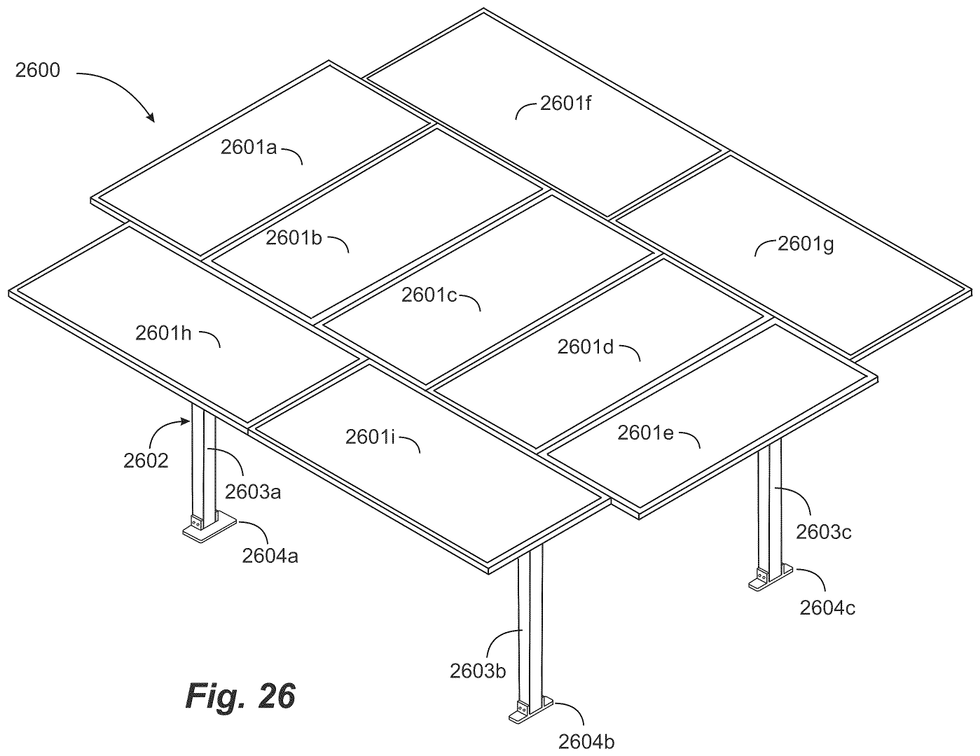

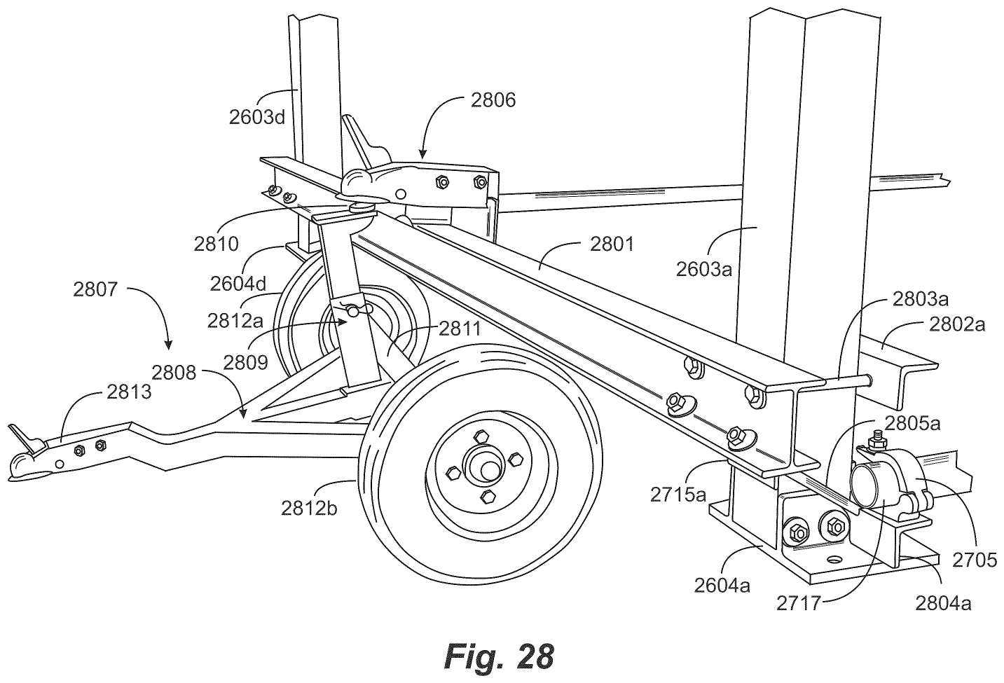

FIG. 26 is a perspective view of a free-standing canopy appliance 2600 in one embodiment of the invention that may be positioned in a user's driveway or other location, and may be used as a carport. Equipped with solar panels this appliance may be used to generate electricity as described in enabling detail above. In this example TEGA canopy appliance 2600 comprises nine (9) bifacial solar panels 2601a through 2601i, In FIG. 26 panels 2601a through 2601i are carried on a sturdy framework 2602 having four corner posts 2603a through 2603d (three corner posts are visible in FIG. 26) that are made in this example from 4″×4″ aluminum square tube stock. In one embodiment the wall thickness of the square tube stock is ⅛ inch, but in some instances, for a more sturdy version, tubes with a wall thickness of 3/16 inch or even ¼ inch may be used. In the example of FIG. 26 each post has a bolted-on saddle-shaped foot noted in the Fig. as feet 2604a, 2604b and 2604c (2604d is not seen). Detail of the feet is provided additionally below in FIG. 28. The added feet provide a sturdy base for the corner posts by increasing the area of surface contact. In FIG. 26 the solar panels are shown in a raised position such that all panels are substantially in a horizontal plane. In another circumstance outer panels 2601f, 2601g, 2601h and 2601i as well as end panels 2601a and 2601e may be folded down to a vertical planar aspect and may be secured in the down position in a circumstance where a TEGA canopy appliance may be moved or towed as a trailer.

To convert the canopy appliance 2600 of FIG. 26 into a street-legal trailer it is necessary to provide wheels joined to the frame 2602. In one embodiment removable wheels are assembled to posts 2603b and 2603c with springs and shock absorbers. In this embodiment the end of the frame with posts 2603b and 2603c is the rear of the trailer. A dolly is provided at a front of the trailer to carry the front of the trailer and to connect to as trailer hitch on a towing vehicle. Details of the dolly and hitch apparatus are provided in enabling detail below referencing FIG. 28.

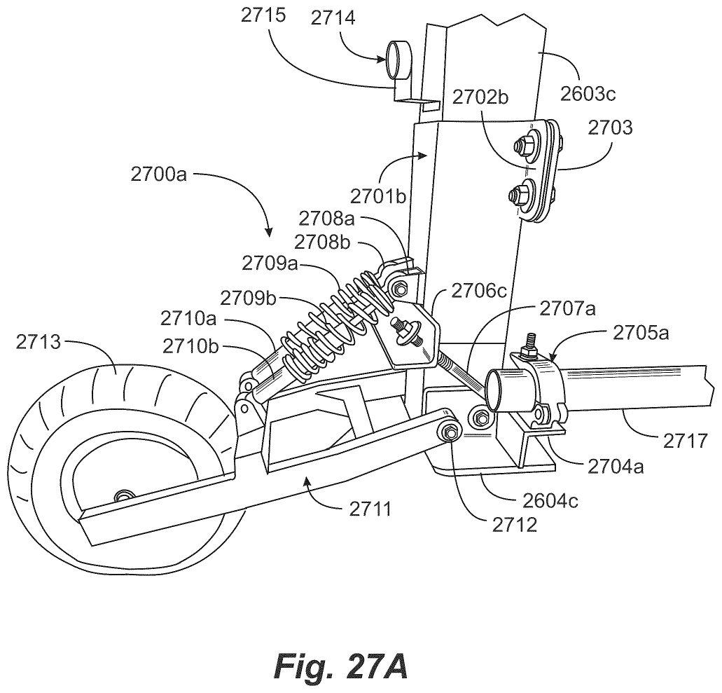

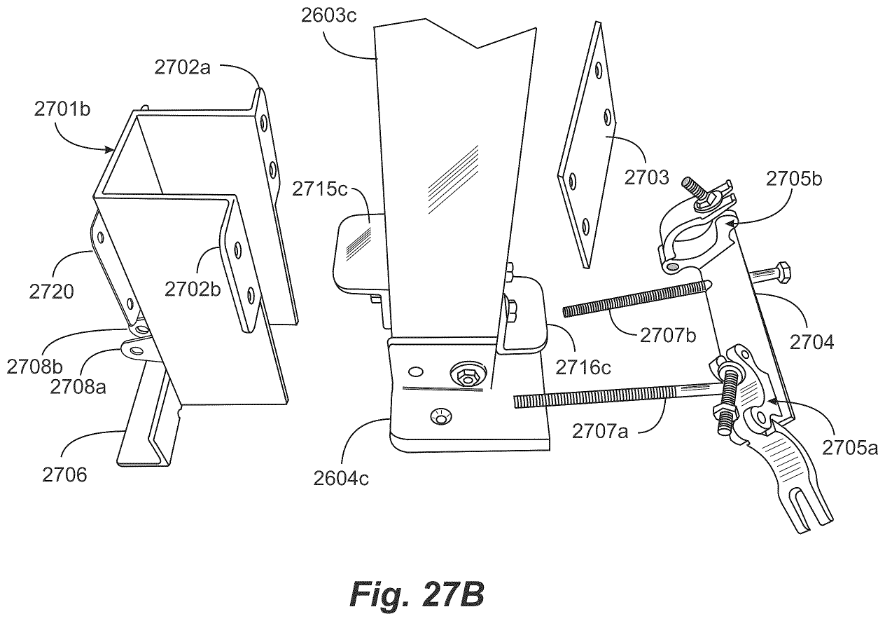

FIG. 27A is a side elevation view of post 2603c with added elements to provide a sturdy wheel assembly 2700a. The direction to the rear is to the left in FIG. 27A. An identical wheel assembly 2700b (not shown) is added to post 2603b to provide two wheels on one end of frame 2602 in a partial conversion to a street-legal trailer. When transformed into a street-legal trailer, posts 2603b and 2603c are on the trailing end of the towed apparatus.

Attachment of wheel assembly 2700a to post 2603c as seen in FIG. 27 is based on a three-sided weldment 2701b which is placed over post 2603c from the rear. Weldment 2701b is shown not engaged to the post in perspective view in FIG. 27B along with some other elements to mount weldment 2701b.

Two angle brackets that bolt to post 2603c to aid in mounting the wheel assembly are not seen in the assembly view of FIG. 27A, but are seen in FIG. 27B as angle brackets 2715c and 2716c. Bracket 2715c presents an upward-facing shoulder at a dimension above that of bracket 2716c, which presents a downward-facing shoulder near the lower extremity of post 2603. Weldment 2701b has an angle bracket 2706c welded across a lower extremity of the weldment and extending outwards on both sides, as seen in both FIG. 27A and FIG. 27B. When weldment 2701b is placed over post 2603c bracket 2706c rests on the upward-facing shelf of bracket 2715c. This circumstance positions weldment 2701b at a correct height on the post. Once in place weldment 2701b is partially secured by a plate 2703 to side brackets 2702a and 2702b of the weldment with conventional bolts and nuts in this example.

An angle bracket 2704a is provided with two holes through at about a 45 degree angle as seen in FIG. 27B and two lengthy bolts 2707a and 2707b pass through the two holes. The bolts pass up through similar angled holes in bracket 2706c welded to weldment 2701b as seen in FIG. 27A. Tightening nuts on these bolts draws bracket 2704 upward under bracket 2716 securely holding weldment 2701b down against the shelf of bracket 2715c, and weldment 2701b is thusly securely anchored to post 2603c.

Bracket 2704a has a first clamp 2705a and a second clamp 2705b securely fastened to bracket 2704, such as by welding. First clamp 2705a secures a long tube 2717 that is used to tie post 2603c to post 2603d in the front of the framework. Second clamp 2705b seen in FIG. 27B serves to secure a similar tube not see that ties post 2603c across the back of the framework to post 2603b on the opposite side. Clamps and posts are also incorporated to tie posts 2603a and 2603b together. These tubes clamped between posts in the trailer version of the framework provide strength and stability in transport.

A plate 2720 shown on weldment 2701b in FIG. 27B is sized and provided to mount a trailer license plate not shown in FIGS. 27A and 27B. Stop, tail lights and turn signal lights are also mounted to post 2603c or to the weldment, and conductors for operating the lights are passed through tube 2717 from the front of the framework when operated as a trailer.

As seen in FIG. 27A a forked frame 2711 is cantilever mounted to post 2603c by a pivot axle 2712 passing through foot 2604c and the post. Frame 2711 mounts a heavy-duty wheel 2713. Frame 2711 is joined to weldment 2701b in this embodiment by two shock absorbers 2710a and 2710b. Heavy-duty compression springs 2709a and 2709b are also implemented with the shock absorbers to provide an effective suspension system. A similar frame and wheel assembly are mounted at post 2603b so the trailer version has wheels on opposite sides of the rear of the trailer.

A tail-stop-turn-signal light 2714 is mounted on a bracket 2715 in a rear-facing portion of post 2603c. This light is conventional art and is wired through, in this example, tube 2717 to the front of the trailer and to a conventional electrical coupler on the rear of the towing vehicle, as is known in the art. A similar tail-stop-turn-signal light is mounted and wired to post 2603b on the other side of the rear of the trailer, so there are two such lights on the rear, as is conventional.

FIG. 28 is a perspective view of a front of the trailer from a corner of post 2603a. Post 2603a and 2503d are seen with feet 2604a and 2604d An I-beam 2801 is mounted at a height above the bottom of the posts with bolts at the sides of the posts through a clamp bracket 2802a and b behind each post. Bolt 2803a and clamp bracket 2802a are seen in FIG. 28.

Referring now to FIG. 27B, it was described above that two angle brackets 2715c and 2716c are bolted to post 2603c creating an upward and a downward facing shoulder. Similar brackets 2715a and 2716a are bolted to post 2603a, but only a portion of bracket 2715a is visible. Brackets 2715d and 2716d are also bolted to post 2603d, but not visible in FIG. 28. I-beam 2801 rests on the upward-facing shoulder of bracket 2715a and is pulled down against that shoulder by two bolts at a 45 degree angle down through bracket 2804a, which is placed under bracket 2716a, not seen. One angled bolt 2805a is seen. I-beam 2801 is anchored to post 2603d in the same way as described here for post 2603a. The I-beam is the main element that secures posts 2603a and 2603d together at the front of the trailer, creating a rigid assembly to withstand the forces experienced as a towed trailer on public roads. A clamp 2705 is seen secured to bracket 2804a clamping a tube 2717 along one side of the trailer between posts 2603a and 2603b.

A conventional trailer hitch 2806 is secured to an upper region of I-beam 2801 midway and extends forward. A road-worthy dolly 2807 is provided to carry the front of the apparatus as a trailer. Dolly 2807 has a sturdy frame 2808 with an upward-adjustable center post 2809 with a hitch ball 2810 at the top of the post. The frame 2808 has an axle 2811 presenting two wheels 2812a and 2812b to the sides of the frame. A second trailer hitch 2813 is implemented on a forward extension of the dolly frame. This trailer hitch is to join to a hitch ball of a towing vehicle such that the trailer version of the canopy apparatus may be towed on public roads.

From the above description is may be seen that a free-standing canopy appliance such as that depicted in FIG. 26 may be converted by addition of a fixed set of elements to a road-worthy and legal licensed trailer, and that the set of elements may be added to the free-standing canopy appliance whenever it is deemed necessary to move the appliance over public roadways to a different location, and that when the appliance is relocated, the set of elements may be removed to leave the free-standing appliance in place to serve its functions as an electricity generator or a carport or both.

A person of ordinary skill will understand that the embodiments described above are each and all exemplary and are not limiting to the scope of the invention, which is limited only by the claims. There are a variety of ways that different features of the invention may be implemented other than the specific ways disclosed in the examples illustrated and described. For example, there are many materials that may be used for the framework other than aluminum tubes. Material suggestions provided herein are exemplary only and not intended to be limiting. Thus disclosed, it will be obvious to a person skilled in the art to select a suitable material. Many sorts of solar panels may be employed. The scope is limited only by the claims.

1. A canopy appliance system comprising:
a free-standing appliance with a rectangular aspect providing a carport, the appliance having four corner posts, two forward and two rear, upper cross-members joining the corner posts, solar panels joined to individual ones of the upper cross-members, and circuitry and wiring connecting the solar panels to a cable ending in a connector compatible with an inverter; and
a first set of add-on elements comprising removable wheel assemblies, stop-tail-signal lights, clamps, tubes, a beam cross piece having a first trailer hitch, a two-wheel dolly with a vertical post having a hitch ball, a forward extension ending in a second trailer hitch, and wiring for the stop-tail-signal lights;
wherein, in a stationary mode with none of the set of add-on elements assembled to the appliance the appliance stands on the four posts and provides a carport and electricity to the inverter connector, and wherein in a trailering mode with the first set assembled, including the removable wheel assemblies on the rear posts, the beam cross-piece on the forward posts, the tubular bracing members clamped between the forward and rear posts on each side, the dolly coupled to the first trailer hitch to present the second trailer hitch forward, and the lights wired, the appliance is configured as a street-legal trailer.

2. The system of claim 1 further comprising a second set of add-on elements comprising ground-anchoring assemblies configured to restrain the appliance against uplift and sliding, wherein in a secured mode the ground-anchoring assemblies of the second set are fastened to one or more posts and to a supporting surface to restrain the appliance.

3. The system of claim 2 wherein the ground-anchoring assemblies comprise (i) hard-surface anchors configured for removable attachment to asphalt or concrete, the hard-surface anchors selected from the group consisting of mechanical expansion anchors, drop-in anchors, wedge anchors, adhesive/chemical anchors, and post-installed anchor sleeves, each engageable through an anchor interface member fixed to the appliance, or (ii) soft-ground anchors comprising helical screws or piles configured to be driven into soil and coupled to the appliance through the anchor interface member.

4. The system of claim 3, wherein the hard-surface anchors comprise adhesive anchors installed in drilled holes and torqued to a specified value, and the anchor interface member includes anti-rotation features selected from serrations, shear keys, or dowel pins.

5. The system of claim 3, wherein the soft-ground anchors comprise helical screws having a coupling bracket that captures a lower edge of the anchor interface member and clamps thereto using a quick-release fastener.

6. The system of claim 3, wherein the anchor interface member is removably coupled to a lower region of a corner post and further comprises a license-plate bracket oriented rearward.

7. The system of claim 3, wherein the anchor interface member includes a load-indicator configured to provide a visual indication when a preset anchor tension or compression threshold is reached.

8. The system of claim 3, further comprising ballast trays configured to receive sandbags or pavers and to interlock with the anchor interface member to increase vertical hold-down in locations where penetrating anchors are restricted.

9. The system of claim 3, wherein the ground-anchoring assemblies are tool-less removable from the appliance, leaving flush or capped anchor points in the supporting surface.

10. The system of claim 1, wherein each removable wheel assembly comprises two shock absorbers and two compression springs arranged in parallel between a three-sided weldment enclosing a rear post and a forked wheel frame pivotably mounted to the post.

11. The system of claim 10, wherein the three-sided weldment presents attachment brackets for ends of the springs and shock absorbers and further carries a rear-facing light pod and a license plate holder.

12. The system of claim 1, wherein the stop-tail-turn-signal lights are wired through the tubular bracing members to a standard trailer electrical connector presented at the forward extension of the dolly.

13. A method for converting a free-standing canopy appliance in a rectangular aspect providing a carport, the appliance having four corner posts, two forward and two rear, upper cross-members joining the corner posts, solar panels joined to individual ones of the upper cross-members, and circuitry and wiring connecting the solar panels to a cable ending in a connector compatible with an inverter, into a street-legal trailer, comprising:
providing a first set of add-on elements comprising removable wheel assemblies, stop-tail-signal lights, clamps, tubes, a beam cross piece having a first trailer hitch, a two-wheel dolly with a vertical post having a hitch ball, a forward extension ending in a second trailer hitch, and wiring for the stop-tail-signal lights; and
assembling the set of add-on elements to the free-standing canopy appliance.

14. The method of claim 13 further comprising securing the appliance against uplift and sliding by coupling ground-anchoring assemblies to a supporting surface through an anchor interface member of the appliance.

15. The method of claim 14, wherein securing the appliance against uplift sliding comprises: (i) for hard surfaces of asphalt or concrete, installing mechanical expansion or adhesive anchors through the anchor interface member into drilled holes; and (ii) for soft ground, driving helical screws into soil and coupling the helical screws to the anchor interface member.

16. The method of claim 13 further comprising providing a suspension system for the street-legal trailer wherein the removable wheel assemblies comprise each, one or more compression springs and shock absorbers.

17. The method of claim 16 further comprising placing and anchoring a three-sided weldment sized to each of the rear posts, wherein with the weldments clamped on the posts and secured, attachment brackets are presented for one end of the compression springs and shock absorbers.

18. The method of claim 16 wherein there are two shock absorbers and two compression springs in each removable wheel assembly.

19. The method of claim 13 comprising wiring the stop-tail-signal lights mounted on the two rear posts through tubes clamped between the forward and the rear posts to a conventional electrical connector at the forward extension of the dolly.

20. The method of claim 17 further comprising mounting a license plate holder facing to the rear.
